(19) United States
(12) Patent Application Publication
(10) Pub. No.: US 2019/0197082 A1
(43) Pub. Date: Jun. 27, 2019

(54) METHOD FOR PREDICTING MECHANICAL, CHEMICAL OR BIOLOGICAL SELF-ASSEMBLY AND AUTONOMOUS ASSEMBLY OCCURRENCES

(71) Applicant: P.J. EDMONSON LTD., Hamilton (CA)

(72) Inventor: Peter J. Edmonson, Hamilton (CA)

(21) Appl. No.: 16/197,728

(22) Filed: Nov. 21, 2018

Related U.S. Application Data
(60) Provisional application No. 62/592,969, filed on Nov. 30, 2017.

(51) Int. Cl. G06F 17/15

(52) U.S. Cl. CPC G06F 17/15; G06Q 50/04

(57) ABSTRACT

There is provided a for predicting occurrences comprising steps of: a) identifying at least two components of the occurrence; b) assigning a binary code to each of the at least two components; c) performing a correlation function between the binary codes; d) determining correlation parameters derived from the correlation function; e) determining interactive parameters derived from physical conditions between the at least two components; f) determining weight functions for each of the correlation and the interactive parameters; g) evaluating, with previously known occurrences, the correlation parameters, the interactive parameters, the weight functions, and the binary codes, to determine if optimized and non-optimized parameters are achieved; h) predicting occurrences with the optimized parameters, the weight functions, and the binary codes; and i) completing the occurrence based on the predicted occurrence. The method can be applied to mechanical, chemical or biological self-assembly occurrences.

### CROSS-REFERENCE TO RELATED APPLICATION

This application claims the benefit of U.S. Provisional Application No. 62/592,969 filed Nov. 30, 2017, the entire contents of which are incorporated herein by reference.

### FIELD OF INVENTION

This invention is related to the field of self-assembly and autonomous assembly. In particular, the invention is related to a method for predicting mechanical, chemical or biological self-assembly and autonomous assembly occurrences.

### BACKGROUND

The art of autonomous assembly and self-assembly, relating to mechanical, chemical or biological nanostructures, mesoscopic or macroscopic structures is a complex subject to model. By definition, self-assembly has three distinctive features:

Order, where the self-assembled structure must have a higher order than the individual building components.

Interactions, where each individual building component has localized interactions with both adjacent and other nearby building components.

Building components, where these three-dimensional components can span a wide range of nanostructures, mesoscopic or macroscopic structures.

Similarly, by definition, autonomous assembly has three major distinctive features:

Independence, such that the decision within the autonomous assembly system to assemble patterns or structures is made without external intervention.

Performing actions within the autonomous assembly system such as the selection of building components to assemble sequences, patterns or structures. This selection depends on the building components' shape, structure, mechanical, chemical or biological nature and position within the overall nanostructure, mesoscopic or macroscopic structures to be assembled.

Degree of autonomy, which is defined by the freedom of action within the autonomous assembly system and the ability to use this freedom of action to complete an independent autonomous assembly. A high degree of autonomy would permit an autonomous assembly system to learn and adapt to new assembly situations.

Autonomous assembly occurrences are accomplished within a complex chemical or biological medium or physically within a manufacturing assembly line or other physical site to assemble or repair a pattern or structure using a robotic machine. The ability either to model these occurrences or to integrate the model parameters within a robotic machine is fundamental to achieving true autonomous assembly techniques.

Several models exist to predict these self-assembly or autonomous assembly occurrences. One is an agent-based model (ABM) that models the autonomous actions and interactions between components and sequences, patterns or structures. Agent based models consists of: a set of agents, where an agent is a discrete entity with its own goals and behaviors and is autonomous with the capability to adopt and modify its behavior, and a set of agent relationships as described by Macal and North, “Introduction to Agent-based Modeling and Simulation,” Argonne National laboratory, Argonne, Ill., Nov. 29, 2006, which describe how ABMs can be processed within simple spread sheets.

For predicting mechanical, chemical or biological self-assembly occurrences several estimating programs exist. These powerful molecular dynamic programs for analyzing and estimating the strength of chemical molecule interactions have also been developed in recent decades, and are considered valuable tools in drug discovery. Inherent in these programs is a mathematical complexity requiring hours of computer processing time to incorporate the electrostatic interactions associated with charged groups, dipole-dipole interactions, quadrapole-dipole interactions.

Prior methods for analyzing and estimating the strength of chemical molecule interactions have been described by Andersson et al., “A Multivariate Approach to Investigate Docking Parameters' Effects on Docking Performance,” J. Chem. Inf. Model., 47 (4), 1673-1687, 2007. Here, Andersson indicates that statistical experimental design and subsequent regression based on root-25 mean-square deviation values using partial least-square projections optimize the parameter settings for selected sets of proteins within the docking program. Certain molecular dynamic and docking type programs utilize the concept of energy functions as outlined by Tietze and Apostolakis in “GlamDock: Development and Validation of a New Docking Tool on Several Thousand Protein-Ligand Complexes,” J. Chem. Inf. Model., 47 (4), 1657-1672, 2007. Tietze and Apostolakis compute a two-dimensional analysis of the effects, which segregates a number of dependencies that are a distinct improvement over the one-dimensional approach. Inherent in both previous mentioned programs is a high level of mathematical complexity requiring a greater amount of computer processing time when compared to low complexity spread-sheet based ABMs.

Prior attempts by Yockey “Information Theory, Evolution, and the Origin of Life,” Cambridge University Press, 2005, ISBN 0-521-80293-8, to transform DNA sequences into digital block codes and then use information theory to evaluate the outcomes are based on the macro scale. Specifically, the micro effects of how individual nucleic acid components interact with respect to each other are minimized and the ability to use correlation techniques to compare the coding techniques.

As an example of current state-of-the-art programs, Moil (Molecular Operations In Life) is a suite of molecular dynamics programs that supports the usual set of tools for molecular modeling by classical mechanics utilizing processes such as, energy calculations, energy minimization and molecular dynamics. Typically, these programs require many molecules to determine the interaction parameters and are not as efficient when a single pair of molecular interaction is required. The complexities of these molecular dynamic programs are typically measured in central processing unit (CPU) years.

Another method that implements correlation functions and a scoring system to find sequence matching is described by Shu et al, “Hypercomplex Cross-Correlation of DNA Sequences,” Journal of Biological Systems, Vol. 18, No. 4, pp. 711-725, 2010. This method uses only the real part of the correlation function to give a score that is used to measure the similarity between an existing DNA substring and the sequence under analysis with no consideration to the correlation sidelobes.

Other examples of the use of engineering and mathematical modeling of biological occurrences have been published to reflect the similarities between technology and biology. Csete and Doyle compare the engineering feedback system and the equations associated with such a system to explain certain characteristics of biological occurrences such as complexity, robustness, modularity, feedback and fragility, M. Csete and J. Doyle, “Reverse Engineering Of Biological Complexity,” 1 Mar. 2002, Vol. 295 Science, pp. 1664-1669.

Another example where a radio is compared to a biological system is reported by Lazebnik and describes the system approach heralded by radio engineers to that of an individual component approach used by many biologists, Y. Lazebnik, “Can a biologist fix a radio?—Or, what I learned while studying apoptosis,” September 2002, Cancer Cell, Vol 2, pp. 179-182.

Edmonson has also compared a two-component quorum sensing biological system of V. harveyi to that of digital radio receiver. The cross-reactivity of the two autoinducers AI-1 and AI-2 are modeled by the cross-product mathematical function. P. Edmonson et al, “Detection of Bacterial Signaling Molecules in Liquid or Gaseous Environments,” K. Rumbaugh, (ed) Quorum Sensing, Methods and Protocols, Vol 692, 2011, Humana Press, pp. 83-100. The results showed the validity of using engineering and mathematical equations to model biological systems.

It is therefore an object of the present teachings to provide a lower mathematical complexity correlation-based binary code model that can be executed within a simple spread sheet in which the appropriate self-assembly or autonomous assembly occurrence of mechanical, chemical or biological components are predicted.

### SUMMARY

In an aspect there is provided a method for predicting self-assembled occurrences comprising steps of a method for predicting occurrences comprising steps of: a) identifying at least two components of the occurrence; b) assigning a binary code to each of the at least two components; c) performing a correlation function between the binary codes; d) determining correlation parameters derived from the correlation function; e) determining interactive parameters derived from physical conditions between the at least two components; f) determining weight functions for each of the correlation and the interactive parameters; g) evaluating, with previously known occurrences, the correlation parameters, the interactive parameters, the weight functions, and the binary codes, to determine if optimized and non-optimized parameters are achieved; h) predicting occurrences with the optimized parameters, the weight functions, and the binary codes; and i) completing the occurrence based on the predicted occurrence.

For non-optimized parameters, steps c) to g) are repeated.

In another aspect of the present teachings, there is provided a method for autonomous assembly by an autonomous machine, comprising steps of: a) identifying at least one component for assembly; b) assigning a first binary code to the at least one component; c) identifying a placement location for assembly;

d) assigning a second binary code to the placement location; e) performing a correlation function between the first and second binary codes; f) determining correlation parameters derived from the correlation function; g) determining interactive parameters derived from thermodynamic and physical conditions between the at least one component and the placement location; h) determining weight functions for each of the correlation parameters and the interactive parameters; i) comparing the correlation function and the interactive parameters;

j) evaluating, during a training session with known components, the correlation parameters, the interactive parameters and the weight functions and determining if optimized and non-optimized conditions are fulfilled; k) placing the identified component to the placement location to be assembled; and l) repeating steps a) to k) until the sequence, pattern or structure is complete, wherein, the components are assembled for a sequence, pattern or structure.

Each different component is assigned a different binary code and a correlation process of the composition of these codes allows for a method to predict the optimum choice and arrangement of these components. Correlation methods may greatly reduce the mathematical complexities inherent in molecular dynamic programs by uniquely creating segmented codes dependent on the characteristics of the chemical or biological components and then using nearest-neighbor (NN) and correlation techniques to study the interaction between components.

This correlation-based method may be used in various biological and biotechnology processes. This method predicts the promiscuous response of antibodies when they are subjected to analogous chemical or biological components. This method may be used to predict the cross-reactivity responses of an antibody with multiple analogous antigens.

This method predicts the assembly of known components into mutable one-dimensional sequences, two-dimensional patterns or three-dimensional structures by autonomous machines. This method would optimize the fit of each known component within the structure. This method would also be useful for the autonomous repair or modification of sequences, patterns or structures.

There is provided a lower mathematical complexity correlation-based binary code model that can be executed within a simple spread sheet in which the appropriate self-assembly or autonomous assembly occurrence of mechanical, chemical or biological components are predicted.

### BRIEF DESCRIPTION OF THE DRAWINGS

Embodiments will now be described, by way of example only, with reference to the accompanying drawings. The skilled person in the art will understand that the drawings, described below, are for illustration purposes only.

FIG. 1A is a flow diagram illustrating the process for predicting mechanical, chemical or biological self-assembly.

FIG. 1B illustrates the process of step 14 of FIG. 1A in more detail;

FIG. 2A illustrates a correlation function derived by a shift and add technique of a 5-bit Barker code.

FIG. 2B depicts a plot of two correlation functions derived from two different 45 bit pseudorandom (PN) coded sequences in accordance with one embodiment.

FIG. 3 illustrates in tabular form the first 10 proteins of the Homosapien RNASEL sequence along with the possible selection of codons available for each protein.

FIG. 4 is a list of the subset grouping of possible codons for the RNASEL sequence.

FIG. 5 illustrates the subset example with corresponding code selection and correlation functions.

FIG. 6 illustrates a set of nitro-based analogous substances.

FIG. 7 illustrates the assignment of binary oriented codes to chemical or biological components within a non-sequential arrangement.

FIG. 8 illustrates a normalized state-space map where both measured (squares) and predicted (triangles) responses to a TNT antibody (Ab) (x-axis) and RDX antibody (Ab) (y-axis) to various nitro-based analogous substances.

FIG. 9 illustrates an autonomous robotic machine assembling a structure.

### DESCRIPTION

The detailed description of exemplary embodiments of the invention herein makes reference to the accompanying block diagrams and schematic diagrams, which show the exemplary embodiment by way of illustration. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented.

Moreover, it should be appreciated that the particular implementations shown and described herein are illustrative of the invention and its best mode and are not intended to otherwise limit the scope of the present invention in any way. Indeed, for the sake of brevity, certain sub-components of the individual operating components, conventional data networking, application development and other functional aspects of the systems may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

Correlation techniques have proven useful in modern digital communications such as code division multiple access (CDMA) and certain radar systems. User data within a CDMA system or an interrogation signal for radar systems are binary coded during the transmit procedure and a correlation process is implemented at the receive procedure to determine the original user data for CDMA or information pertaining to a target for radar.

The binary coding for these systems allows for a spreading of the original spectrum of the data element or interrogation signal. This spread spectrum (SS) technique assigns a unique SS sequence to each CDMA user, which allows the sequences to simultaneously occupy a common transmission channel with a minimum of mutual interference, simplifying the total network control requirements to ensure each user may access the system. Similarly, for radar appliances, SS techniques allow for jam-resistant systems. A more detailed explanation of binary coding for spread spectrum systems and correlation techniques is found in Spread Spectrum Communications Handbook (M. Simon, et al., McGraw-Hill Inc., ISBN 0-07-057629, 1994), which is incorporated herein by reference.

The correlation process may be applied to matched filters. One example of a matched filter system is surface acoustic wave (SAW) filters. The physical structure within the receiver's SAW device is constructed such that the interdigital transducers (IDTs) are patterned after that of the incoming transmitted code. As the coded acoustic wave passes through the receiver's SAW structure, a “shift and add” process takes place that, in effect, produces a correlated output function. A maximum correlated peak and minimum correlated sidelobes occur when an incoming coded signal matches exactly the coded pattern of the SAW device. Perturbations within the peak and sidelobes give useful information to the possible anomalies within the SAW device or the deformation of the coded signal during transmission. A more detailed description of the correlation process can be found in Surface Acoustic Wave Devices for Mobile and Wireless Communications (C. K. Campbell, Academic Press, ISBN 0-120157340-0, 1998), which is incorporated herein by reference.

Matched filters may be used to detect binary sequences of length L, where the sequence is comprised of several different codes. Each different code is concatenated with the others such that the total combined binary length is equal to L. Further information on this technique is illustrated in SAW Pulse Compression Using Combined Barker Codes, (P. J. Edmonson, Master Thesis, McMaster University, 1989), and Study of SAW Pulse Compression Using 5×5 Barker Codes with Quadraphase IDT Geometries, (P. J. Edmonson et al., Proc. IEEE Ultrasonics Symposium, 1988), which are incorporated herein by reference. Codes used for such correlation methods include, but are not limited to Barker codes, pseudorandom (PN) codes of various bit lengths, orthogonal codes commonly referred to as Gold codes, semi-orthogonal codes, Frank codes, and frequency modulated (FM) based codes.

The filter is matched to an input signal s(t) and is characterized in the time domain by an impulse response h(t):

h(t)=s(τ−t) Eq (1)

which is a time reversed and delayed version of s(t).

The output of the matched filter y(t) involves the integration of the product of s(t) and h(t):

y(t)=∫_{-∞}^{∞}s(t)s(τ−t)dt Eq (2)

which is the correlation function between the received signal s(t) and the expected signal h(t).

This output y(t) typically has a large main peak with a distribution of sidelobes on either side of the main peak. The height of the sidelobes with respect to the main peak is quantified by the term peak-to-sidelobe level (PSL), where the ratio of the amplitude of the main peak is compared to the highest absolute sidelobe amplitude. This PSL value is a function of the composition of the input signal s(t) as outlined by the previous two references.

The application of matched filters to radar systems indicates that the parameters such as the Doppler resolution are inversely proportional to the processing interval. This implies that the longer the processing duration such as a longer s(t), the finer the resolution or detail.

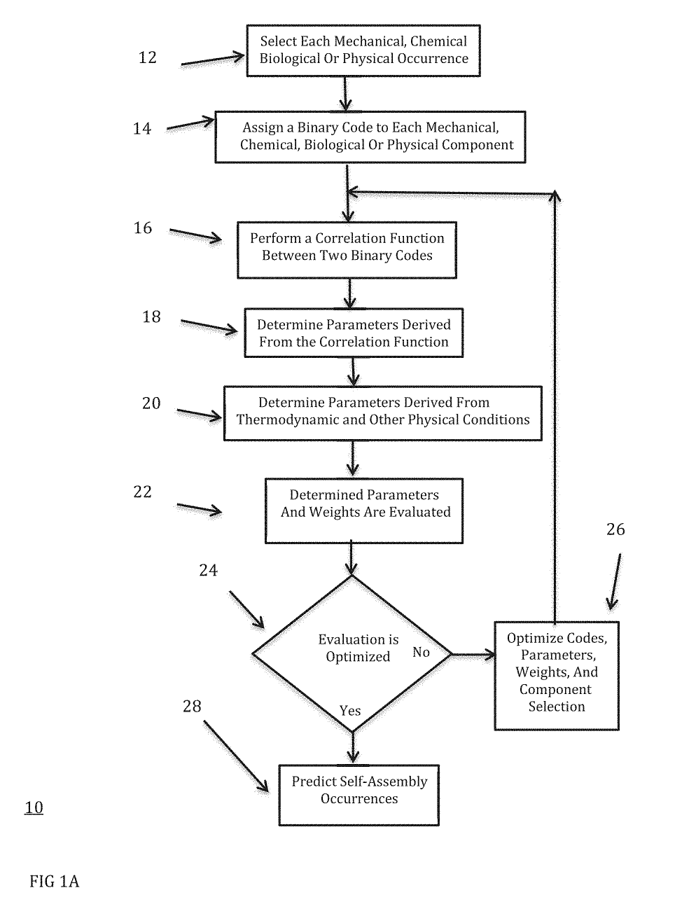

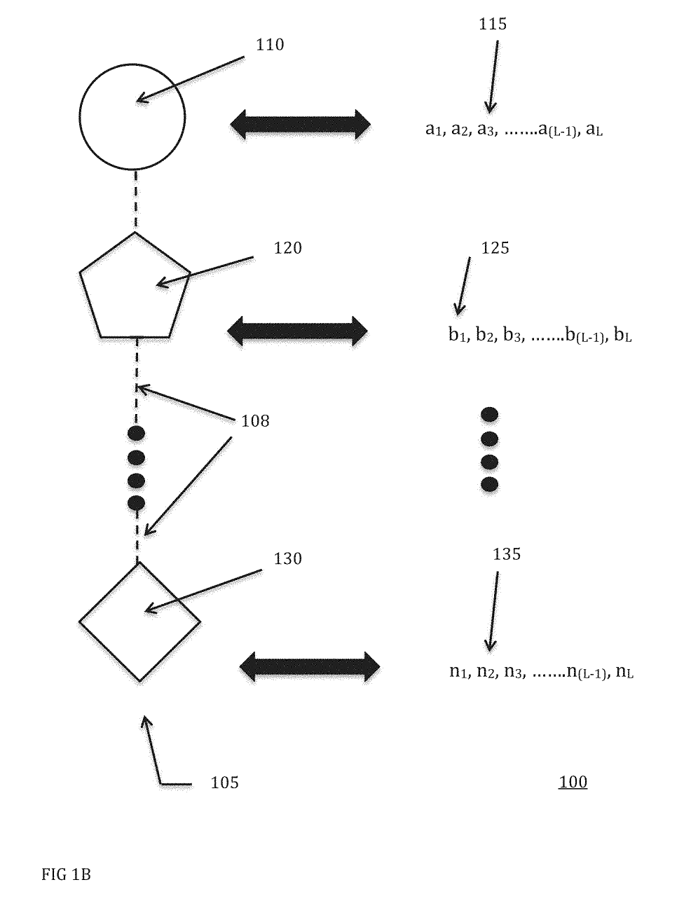

Turning now to FIG. 1A, a process for predicting mechanical, chemical or biological self-assembly occurrences is shown and generally referenced by the reference number 10. Hereinafter the term occurrence will refer to any physical incidence mechanical, chemical or biological incidences. In particular, occurrences include but are not limited to, mechanical, chemical or biological self-assembled occurrences such as amino acid components within a deoxyribonucleic acid (DNA) and single stranded ribonucleic acid (RNA) sequences, or the reactivity of analogous nitro-based explosives and interferer components, or the physical components required to autonomously construct a physical structure are predicted. In step 12, an occurrence is selected to be analyzed for the purpose of constructing or completing the occurrence. In step 14, a binary code is assigned to each mechanical, chemical or biological component for self-assembled occurrences and physical components for autonomous assembly.

FIG. 1B, illustrates the process of step 14 of FIG. 1A in more detail and is generally referenced by the number 100. A unique binary oriented code is assigned to a sequence such as the mechanical, chemical or biological components 105 of the occurrence. The mechanical, chemical or biological sequence 105 is comprised of at least two components and may extend up to n components. Here, component 110 completes an occurrence by attaching or docking with adjacent component 120. Similarly, component 120 completes an occurrence by attaching or docking with another adjacent component continuing up to component n. This sequence may also be extended in a multi-dimensional sense to include either two-dimensional patterns or three-dimensional structures (not shown). For the multi-dimensional case, component 110 would attach or dock with multiple adjacent components 120 up to components 130.

A code is assigned for example, to each of the nucleic acid components, adenine (A), guanine (G), cytosine (C), thymine (T), and uracil (U) of a DNA or RNA sequence. Unique binary codes are generated or chosen from pre-generated lookup tables so as to match component characteristics. The concept of assigning a 1-dimensional code to a 3-dimensional structure has been previously established by others such as, He J., Lu Y., Pontelli E. (2004) A Parallel Algorithm for Helix Mapping Between 3D and 1D Protein Structure Using the Length Constraints. In: Cao J., Yang L. T., Guo M., Lau F. (eds) Parallel and Distributed Processing and Applications. ISPA 2004. Lecture Notes in Computer Science, vol 3358. Springer, Berlin, Heidelberg, where an algorithm maps helices in a 3-dimensional structure to its 1-dimensional structure using the length constraints of helices.

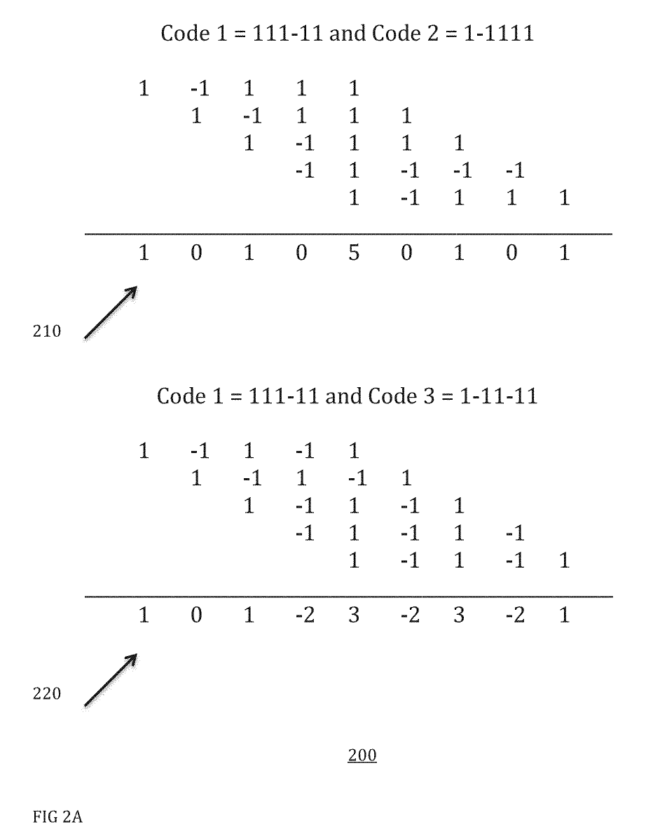

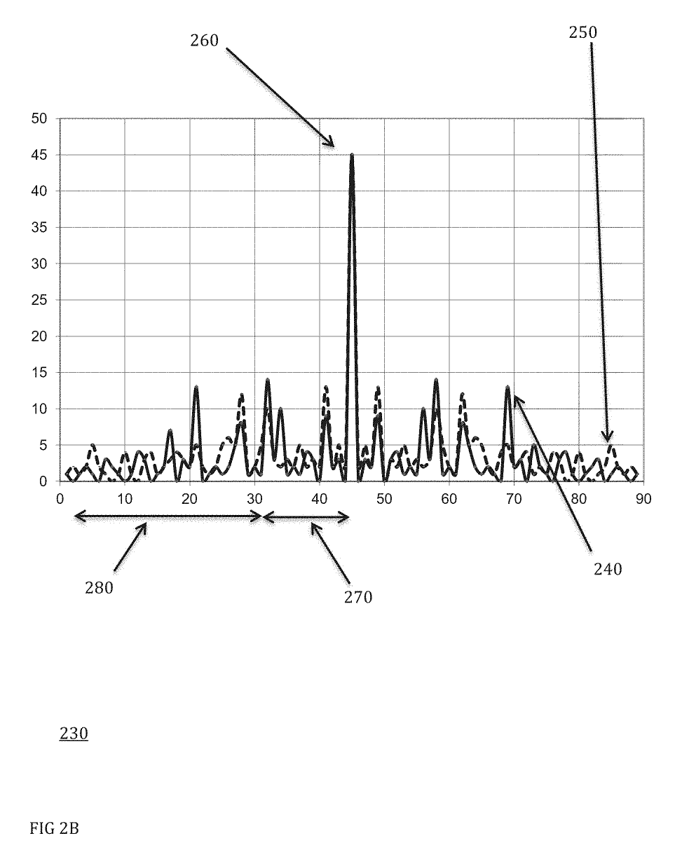

An example of code selection to match component characteristics may be accomplished using orthogonal codes. Adenine (A) may be assigned a Gold code of −111−11−1−1 and Guanine (G) may be assigned another orthogonal Gold code of 1−11−1−1−11. The main characteristic of two orthogonal codes is that they do not correlate with respect to each other and they do not have a strong center peak 260 as shown in FIG. 2B. This orthogonality reflects the characteristic that Adenine does not normally interact with Guanine according to the Watson-Crick base pairs (guanine-cytosine and adenine-thymine). The strong center peak 260 of a typical correlation function as shown in FIG. 2B, where the two codes are not orthogonal but are comparable to each other also provides a processing gain that may also be used to minimize mutual interferences between each of the nucleic acid components since each component resides within a complex fluid medium. These characteristics of the both the codes and correlation function will be demonstrated below.

These components 105 of FIG. 1B, may consist of, but are not limited to, organic, inorganic and other bioinorganic chemical compounds. Each of these mechanical, chemical or biological components 105 has interactive parameters 108 derived from the interactive influences as a result of thermodynamic or physical conditions between adjacent components or other nearest neighbors that are positioned in close proximity with respect to each other. These interactive parameters 108 may be a function of both weak electrostatic interactions such as but not limited to Van der Waals, capillary, π-π and hydrogen bonds and strong electrostatic interactions such as but not limited to covalent, ionic and metallic bonds, thermodynamic data such as entropy ΔG and enthalpy ΔH, temperature and other physical conditions. These physical conditions may include, but are not limited to, melting and boiling points, density, solubility polarity, material composition, appearance, texture and color.

In order to implement a correlation function between components, component A 110 is assigned a binary code A 115. Binary codes A 115, B 125 continuing up to n 135 contain L bits where L>1. This process is repeated for component B 120 by assigning binary code B 125 and continuing for all components up to component n 130 with assigned binary code n 135.

As shown previously for the Adenine (A) code of L=7 bits, −111−11−1−1 and the Guanine (G) code of L=7 bits, 1−11−1−1−11, binary code A 115 is different from binary code B 125 which are different from binary code n 135. However, if within the chemical sequence n 105, there is a repetition of component A 110, or a repetition of component B 120 or any other repetition component up to component n 130, then for each repeated component the respective binary code normally assigned to that component will also be repeated.

In one example, a typical component sequence designated by sequence n 105 that would then have three adjacent components of AGA (Adenine, Guanine, Adenine) are then linearly combined to form a combined code of

Combined Code=(−111−11−1−1 1−11−1−1−11 −111−11−1−1) Eq (3)

This combined code would have a total binary length of NL (21 bits) since the number of codes combined N=3 and the bit length of each code is L=7 bits.

Turning back to FIG. 1A, in step 16, a correlation function is performed between the combined code of at least two adjacent components such as binary code A 115 representing component A 110 and binary code B 125 representing component B 120 and the time reversed and delayed version of the combined code.

A correlation function may be thought of as a shift-and-add function between two binary codes. Example of this shift-and-add are shown in FIG. 2A 200, where a 5-bit barker code, Code 1=(111−11) is used and compared against itself using a time reversed and delayed version of Code 1 to produce Code 2=(1−1111) 210. Each row shows the shifting or delaying action of Code 2 weighted by Code 1 with respect to the previous Code 2 state. A mathematical sum of each column then illustrates a correlation function of 9 bits (2L−1) and a main peak of L, where L=5 bits in length. The processing gain is normally defined as the main peak amplitude. The peak-to-sidelobe level (PSL) for this example is the ratio of the center peak with respect to the highest absolute sidelobe level, which is 5:1=5. The above example is then modified slightly to indicate the usefulness of the correlation function. Here in 220, Code 1=(111−11) but Code 3 is modified by one bit, such that Code 3=(1−11−11). The correlation function between Codes 1 and 3 is still 9 bits in duration however several outcomes have changed, such as, the main peak is 3 and the value of the highest sidelobe=3 resulting in a PSL of 3:3=1. The sidelobe levels have also changed such that some of the sidelobes have negative polarity and the processing gain is also reduced to 3. These negative and positive sidelobe amplitudes will be incorporated into the correlation parameters as will be shown later in Table 2. An interesting ambiguity has also developed, as an upper sidelobe two positions away from the main peak is equal to the main peak.

If a search algorithm was implemented to find the maximum peak value, then for the correlation function illustrated in 210, the main correlation peak located at position 5, of value 5 would be chosen, however for the correlation function illustrated in 220 the search algorithm would find two possible locations at 5 and 7 of value 3.

The shift-and-add correlation function of two binary codes 210 and 220 was demonstrated in FIG. 2A. The shift-and-add correlation function of two combined binary codes 115 and 125 is comparable to the sliding of two concatenated components 110 and 120 into their designated docking site, which is the equivalent to the time reversed and delayed version of the combined binary codes 115 and 125.

Another example of evaluating the differences of two combined codes may be shown by expanding equation (3) to combine three individual 15-bit pseudorandom (PN) codes to form a single combined 45-bit PN code. This initial code is then modified by substituting three different 15-bit PN codes to form another 45-bit PN code. An illustration of the correlation functions of these two different 45 bit PN codes 230 is shown in FIG. 2B. A correlation function of the original 45 bit PN code 240 has a main peak 260 of 45 units located at correlation position 45. Various groups of sidelobes such as the close-in sidelobes 270 and far-out sidelobes 280 are symmetric about the main peak 290.

A comparison between the correlation function of the original 45 bit PN code (solid line) 240 and that of the correlation function of a modified 45 bit PN code (dotted line) 250 illustrates the various changes in the both the amplitude and position of major peaks of the sidelobes, noting that the close-in sidelobes 270 have changed by increasing and the far-out sidelobes 280 have also changed. Since both codes had 45 bits the main peak for both correlation functions remained at 45.

This method of evaluating the differences in sidelobe characteristics allows differences to be detected between two or more codes, which indicates a detection of differences between two or more components. These sidelobe characteristics include both polarized positive and negative amplitudes and the positions of such amplitudes. By asserting certain identified outcomes obtained during training sessions with known components and codes, optimum polarity amplitude values and positions of key sidelobes may be determined. This would assist in determining optimum occurrences of components and their associated binary codes.

Turning back to FIG. 1A, in step 18, correlation parameters derived from the correlation function are computed. Certain correlation parameters of this correlation function may include but not limited to, main peak value, sidelobe values, including both absolute and polarized values, position of sidelobes, sum of the groups of sidelobes including both absolute and polarized values positioned with respect to the main peak and total sum of the sidelobes including both absolute and polarized values.

Table 1 illustrates the comparisons in some of these correlation parameters between the correlation function of a 45 bit PN code 240 and the correlation function of a modified 45 bit PN code 250. The sidelobe positions are calculated starting from the left side of the correlation function and extending to (2L−1) where L=the bit length of the code. The sidelobe values for this example, are the absolute amplitudes measured from the zero reference and similarly the peak value is the absolute amplitude measured from the zero reference. As illustrated in Table 1, sidelobe measurements may be independent of the main peak amplitude.

TABLE 1

| | Maximum | Total | Close-In | Far-Out |
|---|---|---|---|---|
| | Sidelobe | Sidelobe | Sidelobe | Sidelobe |
| Code | Value | Sum | Value | Value |
| 45 bit PN | 14 at position | 122 | 9 at position | 3 at position |
| | 32 | | 41 | 7 |
| Modified 45 | 13 at position | 142 | 13 at position | 5 at position |
| bit PN | 41 | | 41 | 5 |

In FIG. 1A, in step 20, the interactive parameters derived from thermodynamic, other physical conditions data and the correlation function are determined. For example, in predicting DNA sequences, these interactive parameters may be derived from the entropy ΔG and enthalpy ΔH values of the Watson-Crick nearest neighbor orientations.

In step 22, the correlation parameters are evaluated and weights are assigned to each of the correlation and interactive parameters. Examples of how weights are applied will be illustrated later in Table 2, showing W₁CISL, where W₁ is the weight and CISL is the close-in sidelobe parameter. The weight values for each correlation and interactive parameter are iteratively changed with an initial value for all the weights set to equal 1. The purpose of these weights is to either minimize or maximize the effect of the interactive parameter and correlation parameter associated with its corresponding weight during the evaluation process.

In step 24, it is determined whether the evaluation is optimized where this optimization occurs when the optimized conditions correctly predict the known occurrences and when the non-optimized codes do not correctly predict the known occurrences. Steps 16, 18, 20, 22, 24 and 26 are initially considered steps within a training session based on known occurrence outcomes to establish the optimal codes and selected thermodynamic and other physical conditions and weight values for prediction purposes. Optimization occurs when optimized codes correctly predict the known occurrences and the non-optimized codes do not correctly predict the known occurrences. The evaluation is considered optimized when for known outcomes, the selected codes and selected thermodynamic and other physical conditions and weight values predict the correct known result.

If the evaluation has been optimized, then in step 28, occurrences are predicted. If the evaluation has not been optimized, then in step 26, then any or all of the mechanical, chemical or biological sequences 105, binary codes A 115, B 125 continuing up to n 135, correlation and the interactive parameters and weight values are optimized and the method returns to step 16.

This technique of assigning codes and evaluating the various correlation and thermodynamic and other physical parameters is then repeated for other adjacent components along the chemical or biological sequence 105.

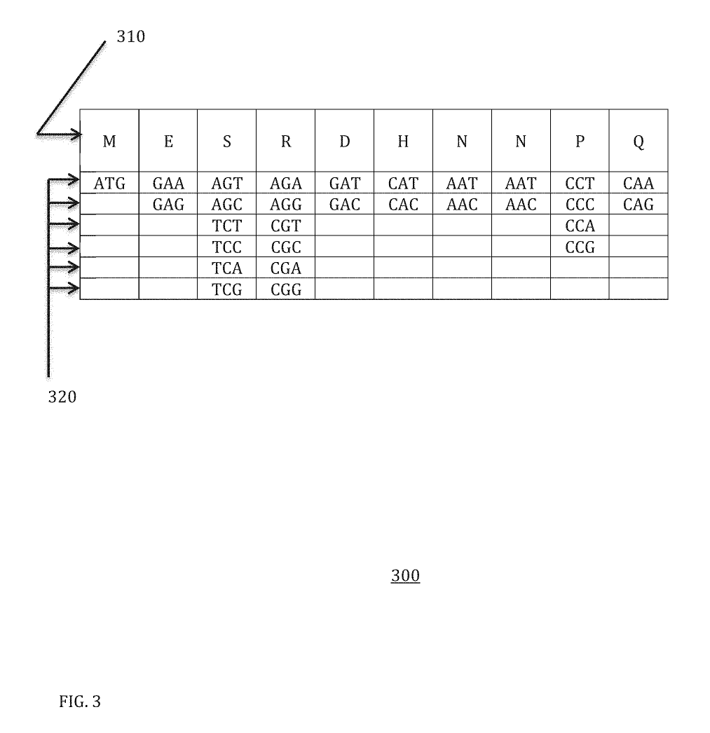

An example of how various chemical or biological components 105 may be defined is further shown in FIG. 3, by illustrating the first ten proteins of the Homosapien RNASEL sequence 300. The top row lists the amino acid single character identifiers 310. The initial component is the start amino acid, Methionine (M, Met) followed by, Glutamate (E, Glu), Serine (S, Ser), Arginine (R, Arg), Aspartate (D, Asp), Histidine (H,His), Asparagine (N,Asn), Asparagine (N,Asn), Proline (P,Pro) and Glutamine (Q,Gln). Listed directly below each of the amino acids are several rows containing possible codons for each amino acid 320.

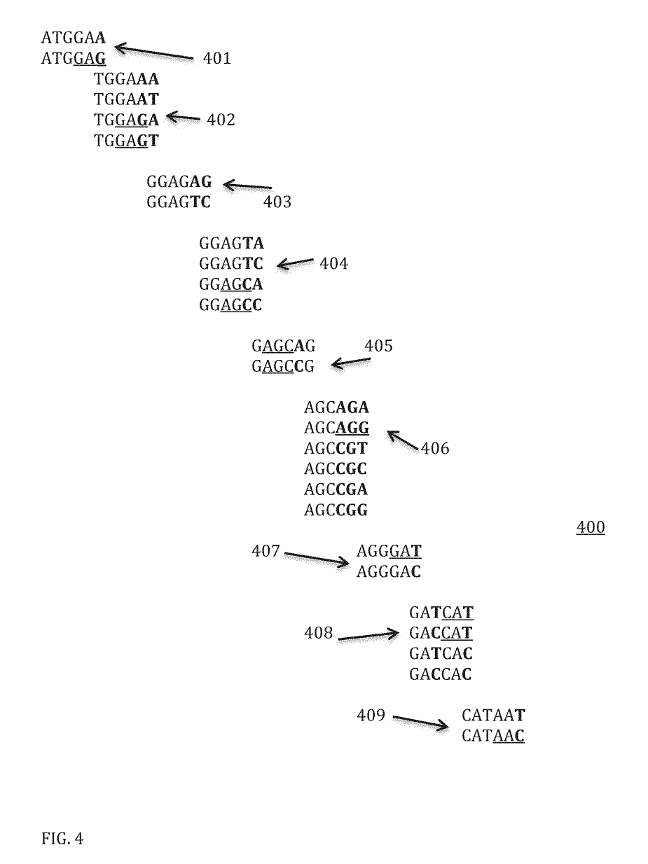

An illustration of the combined grouping of possible codons for the RNASEL sequence 400 is shown in FIG. 4, which shows that not all combined groups need to be formed. Here each of the nucleic acid components, adenine (A), guanine (G), cytosine (C), thymine (T) is assigned a suitable binary code of length n. Each subset is set to a length of 6 nucleic acid components, but this length may vary from a minimum of 2 to x, where x is a number sufficient to achieve a reliable evaluation using the correlation functions and other thermodynamic and physical conditions data. The total bit length of this combined grouping for correlation processing is then xn, where n is the number of bits assigned per component.

For this example, methionine is a start codon and is fixed as the initial codon containing nucleic acid components ATG. Sliding the combined subset of length 6 along the first combined subset comparison 401 is comprised of ATGGAA and ATGGAG, where the ATG components are remnants of the start codon ATG and the GAA and GAG are the two possible codon choices for the glutamate amino acid.

Within FIG. 4, the last nucleic acid components are in bold to signify the change between the two subsets and the GAG codon is underlined to signify the correct codon within the sequence.

Further combined subset choices are shown in the second combined subset comparison 402. Here, the leading nucleic acid components TG, are still a remnant of the start codon ATG and the inner three nucleic acid components are the two choices of codons from the glutamate amino acid (GAA and GAG) and the trailing nucleic acid components (A and T) are from the next possible leading nucleic acid components of the amino acid serine.

The evaluations from the first combined subset comparison 401 and the second combined subset comparison 402 are accumulated and compared to determine the most optimum codon from the glutamate amino acid codons. The derivation of the most optimum codon results from the comparisons of correlation parameters outlined previously in Table 1 and the inclusion of thermodynamic and other physical conditions data. A training session is established where a known chemical or biological sequence 105 is assigned binary codes and various iterations of evaluating both correlation and the interactive parameters outlined in FIG. 1A and determine criteria during subsequent evaluations to determine non-optimum and optimum predictions.

The third combined subset comparison 403, uses the choice of most optimum codon as derived from the first and second combined subset comparisons 401 and 402, as the leading 4 nucleic acid components comprising of the G remnant from the ATG codon and the previous GAG codon. The trailing two nucleic acid components are comprised of the first two nucleic acid components of the next serine codons, namely AG and TC. The evaluations from the combined subset comparison 403 would indicate the optimum choice of the serine codons, namely, those with the prefix AG or TC.

The fourth combined subset comparison 404 implements again the leading 4 nucleic acid components comprising of the G remnant from the ATG codon and the previous GAG codon. However, these subsets solve the ambiguity of selecting either of the two serine codons with prefix AG (AGT and AGC) as the inner components and the first possible nucleic acid component of the next amino acid arginine A and C.

For a more comprehensive confirmation of the combined subset comparison 403, combined subset comparison 404 would also contain as the inner three components the codons TCT, TCC, TCA and TCG to complete all of the possible codon possibilities from the amino acid being included within the subset.

Further evaluations for the fifth, sixth, seventh, eighth and ninth combined subset comparisons, 405, 406, 407, 408 and 409 respectively and continuing to component n 130, using both the correlation functions and other thermodynamic and physical conditions data included within the interactive parameters 108 between components would be completed.

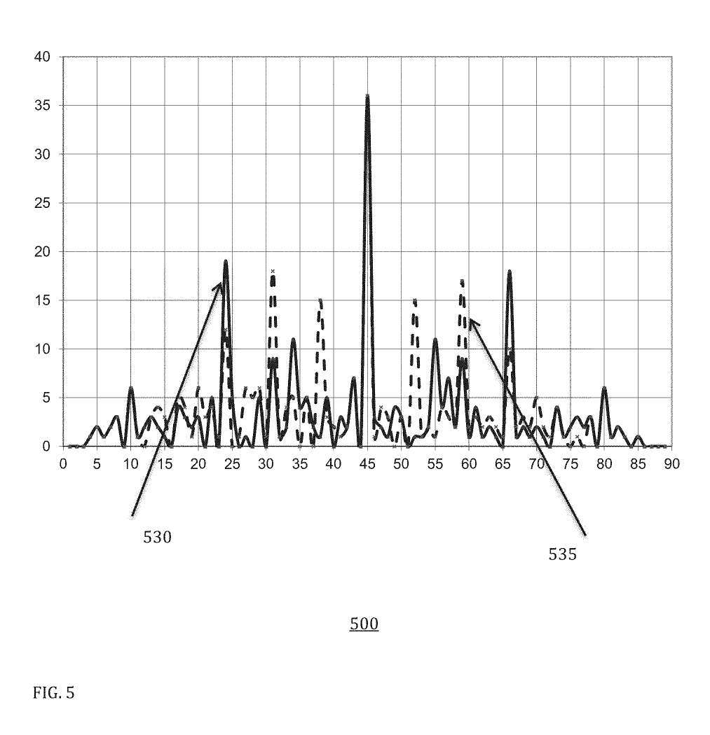

A specific example is now illustrated by demonstrating the comparison of the correlation parameters 500 in FIG. 5. This example is a modification of the fifth combined subset comparison 405, previously shown in FIG. 4. This correlation plot 500 demonstrates a typical comparison of correlation functions between two different sets of combined codes.

Here, in FIG. 5, the correlation functions of the combined subset comparisons of GAGCAG 530 and GAGCCG 535 are shown. The nucleic component codes of adenine (A), guanine (G), cytosine (C), thymine (T) are assigned binary codes as follows;

A=1 1 −1 1 −1 −1 −1 Eq (4)

T=0 1 −1 1 −1 −1 −1 Eq (5)

C=0 −1 −1 −1 1 1 −1 Eq (6)

G=1 −1 −1 −1 1 1 −1 Eq (7)

Since this example relates to the DNA sequence, uracil (U) is not used but would also have a code assigned to it for other examples and applications of this method.

For this example, the code length L=7 bits, with the leading bits of T and C set to zero. The effective length is still then 7 as the zero stuffing bits will not contribute to the magnitude of the correlation function but will contribute to the length of the correlation function as stated in 2[6×7]−1), where 6 is the number of nucleic components within the specified subset and 7 is the total bit length of each assigned component code 115, 125 and 135.

In the step of assigning binary codes lengths, the method of predicting chemical or biological occurrences is significantly improved, as was parameters such as the resolution of comparable Radar matched filters, when the length of the binary codes or processing duration was increased.

The assignment of the binary codes as shown in equations 4, 5, 6 and 7 do not have to be equal in length. The simplicity or complexity of the components with the subsets will determine the length of each assigned binary code. Here, in this example the nucleic component codes of adenine (A), guanine (G), cytosine (C), thymine (T) are all considered the same complexity and therefore are the same in length.

The correlation function y530(t) of combined subset example GAGCAG (solid line) 530 is compared to the correlation function y535(t) of combined subset example GAGCCG (dotted line) 535 of FIG. 5. As previously shown in equation 2, the correlation function y535(t) is derived from the integration of the product of s(GAGCAG) and s(CTGCTC), where CTGCTC is the time reversed, delayed Watson-Crick base pairs (guanine-cytosine and adenine-thymine) version of GAGCAG:

y535(t)=∫_{-∞}^{∞}s(GAGCAG)s(CTGCTC)dt Eq (8)

The main peak amplitudes of both functions are 6×6=36 as the effective length of non-zero bits (7) of the codes outlined in equations 4, 5, 6, and 7 are used to compute the example's amplitude.

The correlation and interactive parameters used for this comparative example of subset codes GAGCAG and GAGCCG, where the serine amino acid codon AGC has a leading nucleic acid component G and two possible trailing nucleic acid components, AG and CG are shown in Table 2 as defined by;

ΔH=thermodynamic enthalpy change (lower value preferred) and

ΔG=thermodynamic entropy change (higher value preferred) as defined in Table 3 of SantaLucia et al, “Improved Nearest-Neighbor Parameters for Predicting DNA Duplex Stability,” Biochemistry, Vol. 36, pp. 3555−3562, 1996 which is incorporated herein by reference.

These selected examples are, but are not limited to, thermodynamic and other physical conditions data of the interactive parameters 108 between adjacent components.

CISL=close-in sidelobe, where the position and absolute value of the highest close-in sidelobe peak with respect to the main peak of the correlation function (lower value preferred).

SLS=the total sum of all the sidelobes on one side of the correlation function excluding the peak (lower value preferred).

CISLS=close-in sidelobe sum, where the first number of sidelobes from the main peak are summed together (lower value preferred).

TSLS=total absolute sidelobe sum of all sidelobes (lower value preferred).

TPSLS=total polarity sidelobe sum of all sidelobes (lower value preferred).

Eval 1=the evaluation of the sum of the ratios of interactive parameters, ΔH, ΔG and the correlation parameters CISL, SLS, CISLS and TSLS.

Weights=W_{A}B=a weighting function where A=the number of codons within the amino acid group and B=the parameter that the weight is assigned to.

Within the first two rows of Table 2, the raw values of the parameters derived from the correlation functions or other sources such as the thermodynamic and other physical conditions data parameters are shown.

Depending upon the training session either the high or low values are preferred. The last two rows of Table 2 are the normalized ratios derived from the values of the columns containing the raw values.

TABLE 2

| Subset | W₂1 ΔH | W₂2 ΔG | W₂3 CISL | W₂4 TPSLS | W₂5 CISLS | W₂6 TSLS | Eval 1 |
|---|---|---|---|---|---|---|---|
| Codes | W₂1 = 0.25 | W₂2 = 7 | W₂3 = 0 | W₂4 = 1 | W₂5 = 0 | W₂6 = 2 | [Low] |
| GAGCAG | −6.14 | −1.16 | 7@43 | 77 | 11 | 66 | |
| GAGCCG | −10.1 | −2.09 | 7@43 | 84 | 19 | 68 | |
| GAGCAG | 0.00 | 0.06 | 0.00 | 0.00 | 0.00 | 0.00 | 0.06 |
| GAGCCG | 0.16 | 0.00 | 0.00 | 0.09 | 0.00 | 0.06 | 0.31 |

For this example, the lowest value of the normalized Eval 1 indicates the correct subset code. Not all weight values within a codon group of 1, 2, 3, 4 or 6 codons need be the same. This includes modifying the weights within the same number of codons group, such as for the case of evaluating the Asparagine amino acid codons AAT and AAC within a subset code CATACC and CATAAT, where the codon CAT was the previous selected Histidine amino acid codon. Here within the subset codes CATACC and CATAAT there appears the combination of either AA and AT or both within the codes. For this example, several of the W₂B weights were then modified within the training session.

In situations where there is a close tie between Eval 1 of two or more possible codon selections, then the mechanical, chemical or biological sequence 105 of FIG. 1, may be extended to include several possible combinations to provide a wider sliding window of assessment to optimize the correct selection of an occurrence.

This correlation-based method may be used in various biological and biotechnology processes. One such example is determining why a variant labeled R462Q occurs within a viral defense gene Ribonuclease L (RNASEL) as described by Silverman R, Urisman A, Molinaro R J, Fischer N, Plummer S J, Casey G, et al. (2006) “Identification of a novel gammaretrovirus in prostate tumors of patients homozygous for R462Q RNASEL variant.”, PLoS Pathog 2(3): e25, which is incorporated herein by reference. Here, the mutant variant replaces the base G at position 1385 with a base A in the cDNA sequence, resulting in an Arginine (R) to Glutamine (Q) transition at position 462 of the protein sequence. By applying this correlated-based method the variant at R462Q shows that in the position 1385 both the G and A bases are very close to having equal correlation characteristics.

An example of this situation was found further into the Homosapien RNASEL sequence 300, where at positions 15, 16 and 17 three serine amino acids are located. The correct subset codons are, for positions 15, 16 and 17, TTC, TTC and AGC respectively. The ambiguities occur within positions 16 and 17 where TCC and AGC have similar or equal Eval 1 values. Here, each subset is set to a length of 6 nucleic acid components and a wider window that would include at least one nucleic component of the next codon. For position 16 three nucleic components of position 17 are used to produce a combined sequence of,

TTCAGC
AGCAGC

Similarly, for position 17 three nucleic components of position 18 are used to produce a combined sequence of,

AGCGGT
TCCGGT

When correlation functions and physical conditions are computed and evaluated between these combined codes and the results are recorded in a table, like table 2. Using this method, the ambiguities developed within positions 16 and 17 were resolved.

This correlation-based method also showed that the variant at position 462 of the viral defense gene Ribonuclease L (RNASEL) of the Arginine codon CGA transitioning to a Glutamine codon CAA had Eval 1 values derived from a similar Table 2 that had the preference of the Arginine codon CGA over the Glutamine codon CAA by 8.1%. Further evaluation showed that the correct subset Arginine codon CGA at position 462 combined with the next correct subset Asparagine codon AAT at position 463,

CGAAAT
CAAAAT

indicating a stronger preference toward the Glutamine codon CAA variant rather than the correct Arginine codon CGA.

Another application according to the present teachings is the prediction between substances and substance-receptor elements. Here a unique code is assigned to a chemical or biological substance and compared to a unique code assigned to a substance receptor element. In some embodiments, the code for the substance and the code for the substance receptor element would be the same. However, for groups of analogous substances, the codes for each analogous substance would be based on a root code with modifications to the root code depending upon the differences between each of the analogous substances.

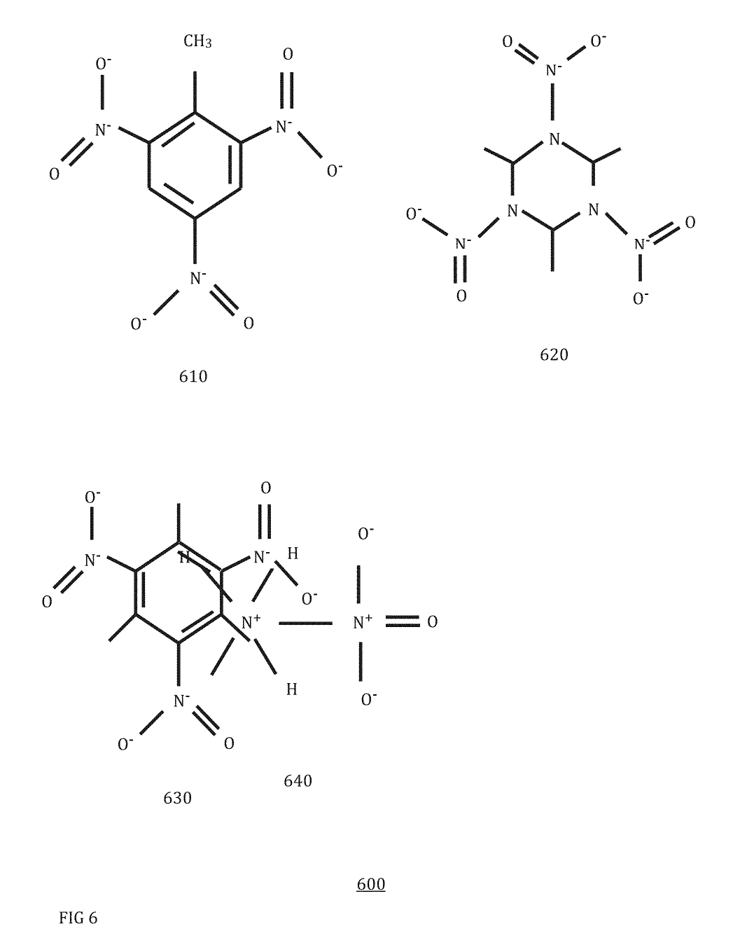

These selected substances may consist of, but not limited to, polymer, organic, inorganic and other bioinorganic chemical compounds. An example of nitro-based selected substance, which may also be an analogous substance 600 is shown in FIG. 6. Here, four nitro-based substances, trinitrotoluene (TNT) 610, cyclotrimethylene trinitramine (RDX) 620, musk oil, musk xylene 630 and ammonium nitrate (AN) 640 are presented.

The explosive cyclotrimethylene trinitramine 620 may be further subdivided into the Research Department Explosive (RDX) and C4 components. C4 contains approximately 90% of RDX, 4−6% of another nitro-based explosive, about 2% amount of plasticizer, about 2% of a synthetic rubber compound and about 2% of an oil.

For this example, several binary codes were derived from orthogonal codes used in CDMA systems as described by Garg and Srivastava, “New Binary User Codes For DS CDMA Communication,” Journal of Engineering Science and Technology, Vol. 6, No. 6, pp. 674−684, 2011 which is incorporated herein by reference. Mathematical programs such as Matlab can readily convert 3-dimensional arrays to 1-dimensional strings, where such a binary code can then be assigned.

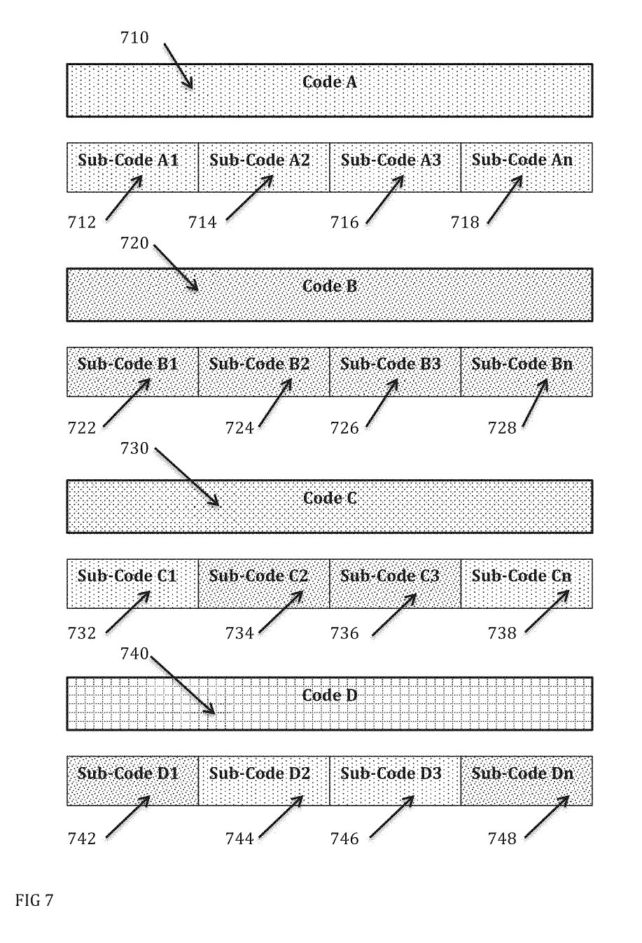

For this example, both the trinitrotoluene (TNT) 610, substance and substance receptor element were assigned Code A 710 of FIG. 7. This code depicts, but is not limited to, a 32-bit orthogonal code derived from Garg and Srivastava. Code A 710, is then partitioned into sub-codes as illustrated in sub-code A1 712, sub-code A2 714, sub-code A3 716 continuing up to sub-code An 718. The bit-length of these sub-codes 712, 714, 716 and 718 need not be equal to each other but the total bit-length=equal the total bit-length of Code A 710.

Code B 720 is then assigned to the Cyclotrimethylene trinitramine (RDX, C4) 620 substance receptor element. Code B 720, is then partitioned into sub-codes as illustrated in sub-code B1 722, sub-code B2 724, sub-code B3 726 continuing up to sub-code Bn 728. The bit-length of these sub-codes 722, 724, 726 and 728 need not be equal to each other but the total bit-length equal the total bit-length of Code B 720.

Code C 730 is then assigned to the Cyclotrimethylene trinitramine (RDX, C4) 620 substance. Since the Cyclotrimethylene trinitramine 620 substance shares commonality with the trinitrotoluene (TNT) 610 substance, then Code C 730 will also share commonality with Code A 710 such that some of the sub-codes such as sub-code C1 732, sub-code C2 734, sub-code C3 736 and continuing up to sub-code Cn 738 would be in common with sub-code A1 712, sub-code 82 724, sub-code 83 726 and continuing up to sub-code An 718 respectively.

Similarly, Code D 740 may be assigned to another nitro-based substance and substance receptor element or both and has a different composition of sub-codes as shown with sub-code D1 742, sub-code D2 744, sub-code D3 746 and continuing up to sub-code Dn 748 where due to commonality of the nitro-based substances, these sub-codes 742, 744, 746 continuing up to 748 would be in common to other respective sub-codes of Code A 710, Code B 720 and Code C 730.

Other codes may be constructed in a similar manner to Code C 730 and Code D 740 using the various sub-codes of Code A 710, sub-code A1 712, sub-code A2 714, sub-code A3 716 continuing up to sub-code An 718 and Code B 720, sub-code B1 722, sub-code B2 724, sub-code B3 726 continuing up to sub-code Bn 728 and Code C 730, sub-code C1 732, sub-code C2 734, sub-code C3 736 continuing up to sub-code Cn 738.

Specific to this example two 32-bit codes were selected from the previous reference by Garg and Srivastava. The first was assigned to the TNT Antibody (Ab) code as is shown in equation (9) and the second to the RDX Ab Code of equation (10).

TNT Ab Code 01110000101110001110001011110001 Eq (9)

RDX Ab Code 01101000111010011001011100010110 Eq (10)

The TNT explosive code of equation (11) was then derived from the time-reversed positioning of the TNT Ab Code of equation (9).

TNT Code 10001111010001110001110100001110 Eq (11)

The RDX explosive code of equation (12) was derived by the combining of the TNT code of equation (11) and the time-reversed positioning of a portion of the sub-code of the RDX Ab code of equation (10) with the sub-code indicated by bold font.

RDX Code 10001111010010011001010100001110 Eq (12)

The remaining explosive codes of Ammonia Nitrate (AN) of equation (13), C4 of equation (14) and Musk of equation (15) were also derived using the combination of the time-reversed TNT Ab code of equation (9) and the time-reversed RDX Ab code of equation (10). The bold font of equations (13), (14) and (15) illustrates the sub-codes derived from the time-reversed RDX Ab code of equation (10).

AN Code 01101111011010011001010100000110 Eq (13)

C4 Code 10001111010001110001111100010110 Eq (14)

Musk Code 10001111010010011001110100001110 Eq (15)

The last 9 binary bits in equations (11), (12), (13), (14) and (15) represent the approximate commonality of the nitro-based molecules that are present within this explosive grouping.

Correlation functions were then performed using each explosive substance codes of equations (11), (12), (13), (14) and (15) and the TNT Ab code of equation (9) and the RDX Ab code of equation (10). Specifically, certain parameters of the correlation functions were used and are shown in Table 3 in a similar fashion according to the previous Table 2, where various correlation parameters between codes assigned to substances and the codes assigned to the substance receptor elements were evaluated.

The values of the sidelobe peaks at positions 30 and 46 were recorded and the upper sidelobe sum (USS) was calculated between positions 46 to 59. This upper sidelobe was then normalized to the lowest of the two values equaling 1.00. The Total column of Table 3 was formulated by taking the product of the absolute values at positions 30 and 46 and the normalized USS. A negative value was assigned to this Total to represent the negative shift in frequency observed during the experiment. The predicted values are the normalized values of the Total column where the normalized value of 1.00 was assigned to the highest Total value between the substance reaction to the TNT and RDX antibodies. The final column of Table 3 represents the normalized experimental data taken for each substance and their reaction to the TNT and RDX antibodies mounted within a vapor phase sensor. The weight functions were set to unity as the data was normalized.

TABLE 3

| | | Absolute | | | | Predicted | |
|---|---|---|---|---|---|---|---|
| | Peak | Peak | | | | Values | |
| Substance | Value At | Value At | | | | (normalized | Experimental |
| Reaction | Position | Position | | USS | | to highest | Values |
| With Ab | 30 | 46 | USS | (normalized) | Total | Total) | (normalized) |
| AN TAb | 6 | 12 | 55 | 1.00 | −72 | −0.41 | −0.55 |
| AN RAb | 12 | 20 | 75 | 0.73 | −176 | −1.00 | −1.00 |
| Musk TAb | 6 | 24 | 67 | 0.60 | −87 | −1.00 | −1.00 |
| Musk RAb | 8 | 8 | 55 | 1.00 | −64 | −0.73 | −0.72 |
| RDX Tab | 4 | 22 | 71 | 0.75 | −66 | −0.66 | −0.78 |
| RDX RAb | 10 | 10 | 53 | 1.00 | −100 | −1.00 | −1.00 |
| C4 Tab | 6 | 26 | 117 | 0.42 | −65 | −0.91 | −1.00 |
| C4 RAb | 12 | 6 | 49 | 1.00 | −72 | −1.00 | −0.85 |
| TNT Tab | 4 | 32 | 111 | 0.46 | −59 | −1.00 | −1.00 |
| TNT RAb | 6 | 0 | 51 | 1.00 | 0 | 0.00 | −0.06 |

The thermodynamic data components ΔH and ΔG were initially set to zero for this example, but other thermodynamic and physical conditions data interactive parameters associated with the nitro-based analogous substances 600 or other chemical or biological substances and substance receptor elements could be used.

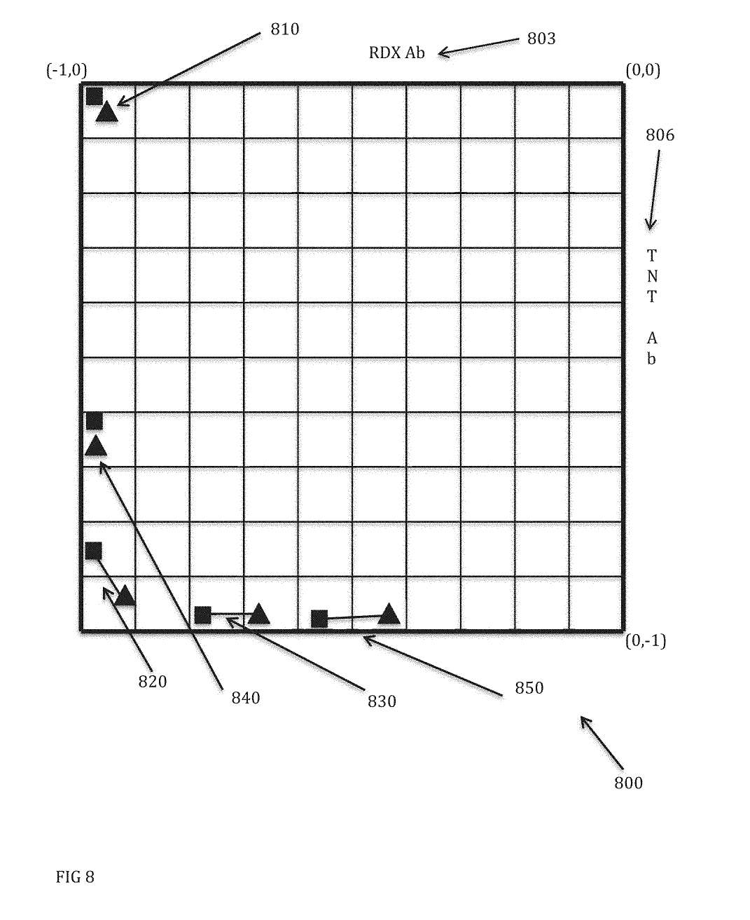

The data within the Predicted values and Experimental Values of Table 3 are illustrated in the state-space mapping of nitro-based substances 800 of FIG. 8. Here, the x-axis is the normalized Cyclotrimethylene trinitramine (RDX) antibody receptor response 803 and the y-axis is the normalized trinitrotoluene (TNT) antibody receptor response 806. The experimental measured data (squares) was derived from averaging and normalizing the data used to illustrate FIG. 4b of W. D. Hunt, S. H. Lee, D. D. Stubbs, and P. J. Edmonson, “Clues From Digital Radio Regarding Biomolecular Recognition,” IEEE Transactions On Biomedical Circuits And Systems, Vol. 1, No. 1, March 2007, which is incorporated herein by reference. The predicted data (triangles) was derived from the values of Table 3 for substances TNT (810), C4 (820), RDX (830), Musk (840) and AN (850) reactive occurrences with receptor TNT and RDX antibodies.

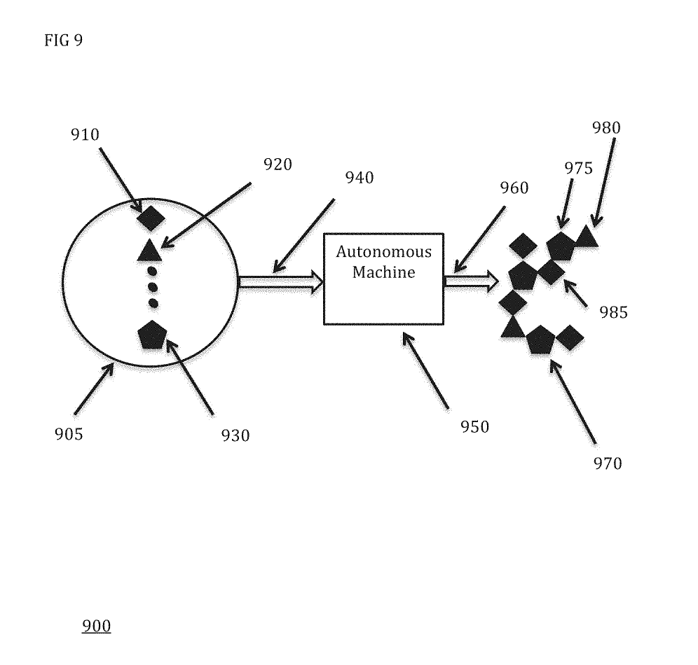

Autonomous assembly identifies a set of established components and forms an organized structure as a result of interactive relations amongst the components without any external guidance. An example of how this method for predicting and autonomously assembling, repairing or modifying physical sequences, patterns or structures using an autonomous robotic machine is shown in 900 of FIG. 9. Here, a bin, hopper or other containment type device 905 contains the various components 910, 920 and up to the nth component 930 that will be used to assemble, repair or modify a physical sequence, pattern or structure 970. The various components 910, 920 and up to the nth location component 930 located within the containment type device 905 are physically identified by the autonomous robotic machine 950 by, but not limited to, optical, echo location, bar code, radio frequency identification devices (RFIDs) or physical tactile probes methods.

An autonomous robotic machine 950 selects the appropriate component either being 910, 920 and up to the nth component 930 from containment device 905 and passes via the autonomous robotic machine 950 through a physical distance 940 from the containment device 905 onward through another physical distance 960 to the appropriate placement location within the sequence, pattern or structure 970.

The attachment or docking locations of the sequence, pattern or structure 970 abuts at least one adjacent location component and possibly multiple-dimensional adjacent location components 975, 980 and up to the ith location component 985. The attachment or docking location and possible location components 975, 980 and up to the ith location component 985 are all physically identified by the autonomous robotic machine 950 by, but not limited to, optical, echo location, bar code, radio frequency identification devices (RFIDs) or physical tactile probes methods.

The binary code assigned to this attachment or docking location would be partitioned into sub-codes, as previously shown in FIG. 7, where each sub-code 712, 714, 716 and up to 718 would be part of the neighboring location components 975, 980 and up to the ith location component 985 that abuts the attachment or docking location. Binary codes are also assigned to each of the various components 910, 920 and up to the nth component 930 that will be used to assemble, repair or modify a physical sequence, pattern or structure 970.

The autonomous robotic machine 950 will follow in a similar fashion the steps previously outlined in FIG. 1A, where binary codes are assigned to each component and for this application, a placement location 14, a correlation function is performed between at least two binary codes 16. Parameters are then determined from the correlation function 18 and interactive parameters from thermodynamic or other physical conditions 20. These interactive parameters may include but are not limited to entropy ΔG and enthalpy ΔH and the physical conditions which may include, but are not limited to, melting and boiling points, density, solubility, polarity, material composition, appearance, texture and color.

A training session of a pre-determined assembled structure is carried out with external guidance and where these parameters and weight functions are evaluated

22 and optimized until the training session is complete and the pre-determined structure may be assembled without any external guidance.

During a typical autonomous assembly session where the interactive and correlation parameters have been optimized via the training session, the autonomous robotic machine attaches the component within the attachment or docking location of the sequence, pattern or structure as determined by the flow chart of FIG. 1A to autonomously assemble, repair or modify the sequence, pattern or structure 970. This process is repeated until the autonomous robotic machine 950 determines that the sequence, pattern or structure 970 is complete.

In understanding the scope of the present application, the articles “a”, “an”, “the”, and “said” are intended to mean that there are one or more of the elements, unless specifically stated otherwise. The use of “or” means “and/or”, unless specifically stated otherwise. Additionally, the term “comprising” and its derivatives, as used herein, are intended to be open ended terms that specify the presence of the stated features, elements, cores, groups, integers, and/or steps, but do not exclude the presence of other unstated features, elements, cores, groups, integers and/or steps. The foregoing also applies to words having similar meanings such as the terms, “including”, “having” and their derivatives.

It will be understood that any aspects described as “comprising” may also “consist of” or “consist essentially of,” wherein “consisting of” has a closed-ended or restrictive meaning and “consisting essentially of” means including the components or steps specified but excluding other components or steps except for materials present as impurities, unavoidable materials present as a result of processes, and components added for a purpose other than achieving the technical effect of the invention.

It will be understood that any feature defined herein as being included may be explicitly excluded from the claimed invention by way of proviso or negative limitation. In addition, all ranges given herein include the end of the ranges and any intermediate range points, whether explicitly stated or not.

Terms of degree such as “substantially”, “about”, “significantly” and “approximately” as used herein mean a reasonable amount of deviation of the modified term such that the end result is not majorly changed. These terms of degree may be construed as including a deviation of at least ±5% of the modified term if this deviation would not negate the meaning of the word it modifies.

While the Applicant's teachings have been described in conjunction with various embodiments and examples, it is not intended that the applicant's teachings be limited to such embodiments or examples. On the contrary, the Applicant's teachings encompass various alternatives, modifications, and equivalents, as will be appreciated by those of skill in the art, and all such modifications or variations are believed to be within the sphere and scope of the invention.

What is claimed is:

1. A method for predicting occurrences comprising steps of:
a) identifying at least two components of the occurrence;
b) assigning a binary code to each of the at least two components;
c) performing a correlation function between the binary codes;
d) determining correlation parameters derived from the correlation function;
e) determining interactive parameters derived from physical conditions between the at least two components;
f) determining weight functions for each of the correlation and the interactive parameters;
g) evaluating, with previously known occurrences, the correlation parameters, the interactive parameters, the weight functions, and the binary codes, to determine if optimized and non-optimized parameters are achieved;
h) predicting occurrences with the optimized parameters, the weight functions, and the binary codes; and
i) completing the occurrence based on the predicted occurrence.

2. The method of claim 1, wherein for non-optimized parameters, steps c) to g) are repeated with modified codes, parameters, weights and component selection.

3. The method of claim 1 wherein steps b) to g) are a training session for known occurrences.

4. The method of claim 1, wherein the correlation function is
y(t)=∫_{-∞}^{∞}s(t)s(τ−t)dt

5. The method of claim 1, wherein the occurrences are biological.

6. The method of claim 1, wherein the occurrences are chemical.

7. The method of claim 1, wherein the occurrences are physical.

8. The method of claim 1, wherein the binary codes are selected from the group consisting of Barker codes, pseudorandom codes, orthogonal codes commonly referred to as Gold codes, semi-orthogonal codes, Frank codes, and frequency modulated (FM) based codes.

9. The method of claim 1, wherein the binary code is based on a root code for a selected substance.

10. The method of claim 8, wherein the binary root code is modified for selected analogous substances.

11. The method of claim 1, wherein the correlation function is derived from at least two binary codes.

12. The method of claim 1, wherein the determining parameters include the correlation function amplitudes and positions of the amplitudes.

13. The method of claim 12, wherein the determining parameters include a main peak amplitude, the sum of selected sidelobe amplitudes, a position and amplitude of a sidelobe or both a main peak amplitude and a sidelobe amplitude.

14. The method of claim 1 wherein the physical conditions include thermodynamic data, entropy ΔG, enthalpy ΔH, weak electrostatic interactions, strong electrostatic interactions, melting and boiling points, density, solubility, polarity, material composition, appearance, texture and color.

15. A method for autonomous assembly by an autonomous machine, comprising steps of:
a) identifying at least one component for assembly;
b) assigning a first binary code to the at least one component;
c) identifying a placement location for assembly;
d) assigning a second binary code to the placement location;
e) performing a correlation function between the first and second binary codes;
f) determining correlation parameters derived from the correlation function;
g) determining interactive parameters derived from thermodynamic and physical conditions between the at least one component and the placement location;
h) determining weight functions for each of the correlation parameters and the interactive parameters;
i) comparing the correlation function and the interactive parameters;
j) evaluating, during a training session with known components, the correlation parameters, the interactive parameters and the weight functions and determining if optimized and non-optimized conditions are fulfilled;
k) placing the identified component to the placement location to be assembled with the optimized parameters, the weight functions, and the binary codes; and
l) repeating steps a) to k) until the sequence, pattern or structure is complete, wherein, the components are assembled for a sequence, pattern or structure.

16. The method of claim 15, wherein for non-optimized parameters, steps e) to k) are repeated with modified codes, parameters, weights and component selection.

17. The method of claim 15, wherein the correlation function is
y(t)=∫_{-∞}^{∞}s(t)s(τ−t)dt

18. The method of claim 15, wherein the sequence, pattern or structure are biological.

19. The method of claim 15, wherein the sequence, pattern or structure are chemical.

20. The method of claim 15, wherein the sequence, pattern or structure are physical.

21. The method of claim 15, wherein the binary codes assigned to each component are selected from the group consisting of Barker codes, pseudorandom codes, orthogonal codes commonly referred to as Gold codes, semi-orthogonal codes, Frank codes, and frequency modulated (FM) based codes.

22. The method of claim 15, wherein the binary code is based on a root code for a selected component.

23. The method of claim 22, wherein the binary root code is modified for selected analogous components.

24. The method of claim 15, wherein the correlation function is derived from at least two binary codes.

25. The method of claim 15, wherein the determining parameters include the correlation function amplitudes and positions of the amplitudes.

26. The method of claim 25, wherein the correlation function parameters include a main peak amplitude, the sum of selected sidelobe amplitudes, a position and amplitude of a sidelobe or both a main peak amplitude and a sidelobe amplitude.

27. The method of claim 15 wherein the physical conditions include thermodynamic data, entropy ΔG, enthalpy ΔH, weak electrostatic interactions, strong electrostatic interactions, melting and boiling points, density, solubility polarity, material composition, appearance, texture and color.

28. The method of claim 15 wherein the identification of the component is accomplished by optical, echo location, bar code, radio frequency identification devices (RFIDs), or physical tactile probes methods.

29. The method of claim 15 wherein the identification of the placement location is accomplished by optical, echo location, bar code, RFIDs, or physical tactile probes methods.

30. The method of claim 15 wherein the assembly is a repair.

31. The method of claim 15 wherein the assembly is a modification.


SEQUENCE LISTING (2 sequences)

SEQ ID NO: 1 - protein, 10 aa, Homo sapiens
MESRDHNNPQ

SEQ ID NO: 2 - DNA, 30 bp, Homo sapiens
  misc_feature (6)..(6): n = a or g
  misc_feature (7)..(7): n = a or t
  misc_feature (8)..(8): n = g or c
  misc_feature (9)..(9): n = t, c, a, or g
  misc_feature (10)..(10): n = a or c
  misc_feature (12)..(12): n = a, g, t, or c
  misc_feature (15)..(15): n = t or c
  misc_feature (18)..(18): n = t or c
  misc_feature (21)..(21): n = t or c
  misc_feature (24)..(24): n = t or c
  misc_feature (27)..(27): n = t, c, a, or g
  misc_feature (30)..(30): n = a or g
atggannnnngngancanaanaanccncan